(19) United States
(12) Patent Application Publication
(10) Pub. No.: US 2026/0371423 A1
(43) Pub. Date: Nov. 19, 2026

(54) COMMUNICATION SYSTEM WITH MULTIPLE DONGLES AND CURSOR CONTROL METHOD THEREOF

(71) Applicant: PixArt Imaging Inc., Hsin-Chu County (TW)

(72) Inventors: Ping-Shun ZEUNG, Hsin-Chu County (TW); Chung-Han HSIEH, Hsin-Chu County (TW); Kun-Yuan LIN, Hsin-Chu County (TW)

(21) Appl. No.: 19/464,605

(22) Filed: Jan. 30, 2026

Related U.S. Application Data
(60) Provisional application No. 63/807,926, filed on May 19, 2025.

(51) Int. Cl. H04W 76/15; H04W 4/80; H04W 48/16

(52) U.S. Cl. CPC H04W 76/15; H04W 48/16; H04W 4/80

(57) ABSTRACT

There is provided a communication system including a host dongle and multiple client dongles. The host dongle is coupled to a first computer via a USB interface. The multiple client dongles are coupled to multiple computers respectively via multiple USB interfaces. In an operation phase, the host dongle is used to keep connection states with the multiple client dongles simultaneously via respective RF channels to switch a controlled target of an input device associated with the first computer between the first computer and the multiple computers.

### CROSS REFERENCE TO RELATED APPLICATION

The present application claims the priority benefit of U.S. Provisional Application Ser. No. 63/807,926, filed on May 19, 2025, the disclosure of which is hereby incorporated by reference herein in its entirety.

### FIELD OF THE DISCLOSURE

This disclosure generally relates to a communication system and, more particularly, to a communication system with multiple dongles for switching a controlled target of an input device among multiple computers via multiple pre-paired dongles, and a cursor control method of the communication system.

### BACKGROUND OF THE DISCLOSURE

Please refer to FIG. 1, it is a schematic diagram of a conventional computer communication system, including a wireless mouse 11 wirelessly coupled to a first computer PC1 via a first channel CH1 and a first dongle 131 or wirelessly coupled to a second computer PC2 via a second channel CH2 and a second dongle 132.

When the wireless mouse 11 is wirelessly connected to the first computer PC1, the wireless mouse 11 can be used to control cursor movements or click operations on the first computer PC1. When a user presses a hotkey on the wireless mouse 11, the first channel CH1 is interrupted, and then the wireless mouse 11 establishes the second channel CH2. In this way, the user can control the second computer PC2 using the wireless mouse 11

However, since the switching procedure requires disconnecting an existing communication channel and then re-establishing a new communication channel, there will be a short time delay, which will reduce the user experience.

Therefore, a communication system is needed that allows input devices to switch between multiple controllable computers without causing a switching time delay during the switching procedure.

The information disclosed in this BACKGROUND is merely intended to increase understanding of the general background of the invention and should not be taken as an admission or in any way implied that the relevant information constitutes prior art that is already known to a person of ordinary skill in the art.

### SUMMARY

Accordingly, the present disclosure provides a communication system including a host dongle for simultaneously maintaining connecting states with multiple client dongles and at least one Bluetooth device, thereby eliminating the perceived time delay during an input device switching a controlled target.

The present disclosure further provides a method for switching a cursor between a computer screen and a smart phone screen (or tablet, or another computer).

The present disclosure provides a communication system including a host dongle and multiple client dongles. The host dongle includes a USB interface configured to be coupled to a first computer. The multiple client dongles respectively include a USB interface configured to be coupled to multiple computers, respectively. The host dongle is configured to keep connection states with the multiple client dongles simultaneously via respective radio frequency (RF) channels to switch a controlled target of an input device associated with the first computer between the first computer and the multiple computers.

The present disclosure further provides a communication system including a host computer and multiple client computers. The host computer is installed with a first application software and coupled to a first dongle. The multiple client computers are respectively installed with an application software and respectively coupled to a dongle. The host computer is configured to respectively establish an RF channel with multiple dongles coupled to the multiple client computers via the first dongle. In switching a controlled target of an input device associated with the host computer between the host computer and the multiple client computers, all RF channels are kept connection states simultaneously.

The present disclosure further provides a cursor control method of a communication system. The communication system includes a computer that establishes a BT channel with a portable device via a dongle. The cursor control method includes the steps of: acquiring, by the computer, a screen resolution of the portable device via the dongle; notifying, by the computer, the dongle to set the screen resolution and a buffer margin of the portable device, wherein the buffer margin is a predetermined pixel region exceeding the screen resolution; forwarding displacement of a mouse to the dongle upon a cursor on a screen of the computer reaching a predetermined boundary of the screen; calculating, by the dongle, an accumulated displacement and controlling a cursor on the portable device according to the displacement forwarded from the mouse; and notifying, by the dongle, the computer to switch a controlled target of the mouse back to the computer only when the accumulated displacement exceeds the buffer margin.

### BRIEF DESCRIPTION OF DRAWINGS

Other objects, advantages, and novel features of the present disclosure will become more apparent from the following detailed description when taken in conjunction with the accompanying drawings.

FIG. 1 is a connecting schematic diagram of a conventional computer communication system.

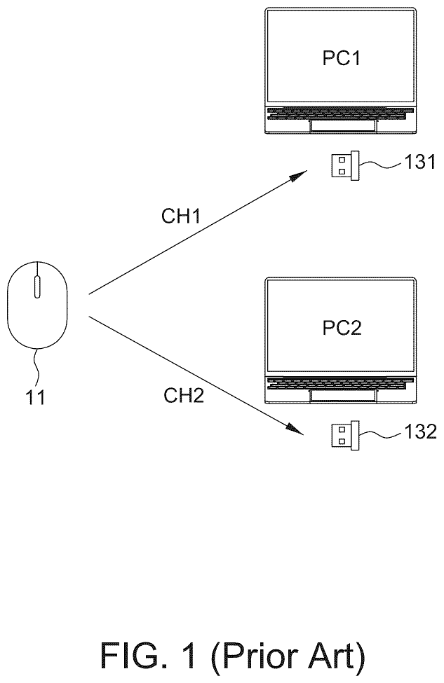

FIG. 2 is a connecting schematic diagram of a communication system according to one embodiment of the present disclosure.

FIG. 3 is an operational schematic diagram of a communication system according to one embodiment of the present disclosure.

FIG. 4 is a flow chart of a cursor control method for a communication system according to one embodiment of the present disclosure.

FIG. 5 is a schematic diagram of a buffer margin and a screen of a smart phone of a communication system according to one embodiment of the present disclosure.

### DETAILED DESCRIPTION OF THE DISCLOSURE

It should be noted that, wherever possible, the same reference numbers will be used throughout the drawings to refer to the same or like parts.

One objective of the present disclosure is to provide a communication system that uses multiple dongles to form multiple radio frequency (RF) channels, which are simultaneously keeping connection states (or referred to online states), among multiple computers of the communication system. In this way, when a controlled target of an input device switches among the multiple computers, communication channels are not interrupted and reconnected to alleviate the switching time delay and to improve the user experience. A dongle of the communication system of the present disclosure may further establish multiple Bluetooth (BT) channels with multiple portable devices simultaneously, and the multiple BT channels and the multiple RF channels are kept connection states, simultaneously.

In the present disclosure, the multiple computers include desktop computers, notebook computers, workstations, central control computers or the like. Each computer has a built-in or a coupled screen, without particular limitations. Each computer has a built-in or a wired/wirelessly coupled input device, such as a mouse device, a keyboard device, a touchpad, a joystick, a ring, an armband, or any other device that is used to input data such as clicks, presses, displacement, rotations, contacts or the like, but the present disclosure is not limited thereto.

In the present disclosure, the multiple portable devices include smartphones, tablets, and other devices equipped with a BT module that is used to BT connect to the dongle connected to a host computer. Each portable device has a built-in screen or a coupled screen, without particular limitations.

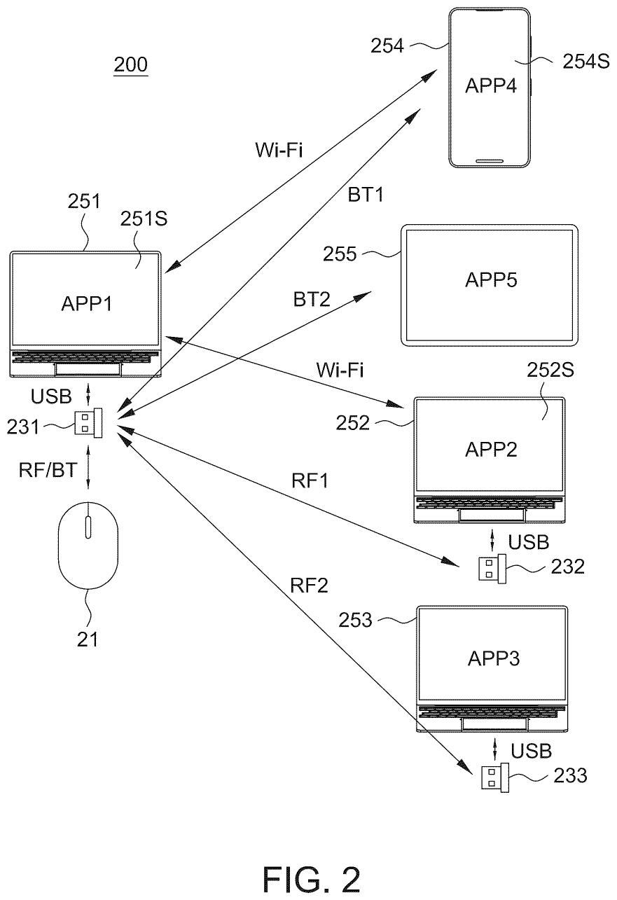

Please refer to FIG. 2, it is a connecting schematic diagram of a communication system 200 according to one embodiment of the present disclosure. The communication system 200 is shown to include an input device 21 (taking a mouse device as an example, but not limited to the mouse device), a host dongle 231 and multiple client dongles 232 and 233.

The host dongle 231 includes a universal serial bus (USB) interface for connecting to a first computer 251, which is therefore referred to as a host computer. The host dongle 231 may be plugged into/out of a USB port of the first computer 251. The first computer 251 is installed with a first application software APP1 for performing the controlled target switching of the input device 21 of the present disclosure, as illustrated below by examples.

In one aspect, the input device 21 is not limited to input equipment that is wired or wirelessly coupled to the first computer 251, but also may be input equipment built into the first computer 251, without particular limitations.

The client dongle 232 includes a USB interface coupled to a second computer 252, which is therefore referred to as a client computer. The client dongle 232 may be plugged into/out of a USB port of the second computer 252. The second computer 252 is installed with a second application software APP2 for performing the controlled target switching of the input device 21 of the present disclosure.

The client dongle 233 includes a USB interface coupled to a third computer 253, which is therefore referred to as a client computer. The client dongle 233 may be plugged into/out of a USB port of the third computer 253. The third computer 253 is installed with a third application software APP3 for performing the controlled target switching of the input device 21 of the present disclosure.

The first computer 251, the second computer 252 and the third computer 253 of the present disclosure may be identical or different types of computers, as long as they respectively have a USB port for plugging and unplugging a dongle.

The communication system 200 of the present disclosure is further shown to include (but not limited to necessarily including) a first portable device 254 and a second portable device 255, they are identical or different types of portable devices.

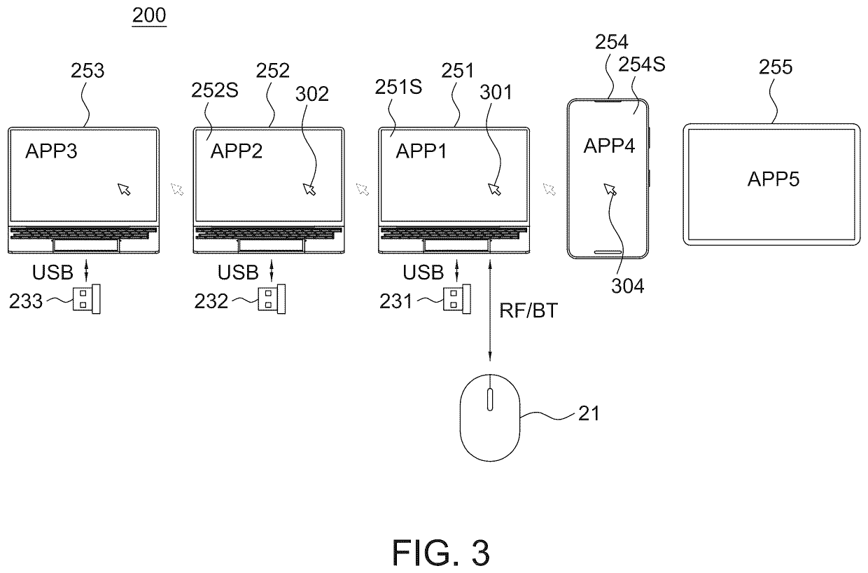

The host dongle 231 is also used to form a first BT channel with the first portable device 254 via a first BT interface, e.g., shown as BT1. The host dongle 231 is also used to form a second BT channel with the second portable device 255 via a second BT interface, e.g., shown as BT2. In one aspect, the host dongle 231 includes a single BT chip that exchanges information with the first portable device 254 and the second portable device 255 in a time-division manner through the first BT channel BT1 and the second BT channel BT2, respectively. The single BT chip is also capable to establish more than two BT channels with more than two BT devices, and is not limited to two shown in FIGS. 2-3.

The application software APP1-APP5 in the present disclosure may be downloaded and installed respectively on the computers 251-253 and the portable devices 254-255 via the Internet, the cloud, the portable memory or the dongle before using the communication system 200, without particular limitations.

In another aspect, the host dongle 231 of the communication system 200 of the present disclosure is only coupled to the portable device(s) via BT channel(s) but not coupled to the computer.

During an operation phase (after the application software is installed and the connection pairing is completed), the host dongle 231 is used to maintain connection states with multiple client dongles (e.g., two dongles 232 and 233 being shown, but not limited to two) through respective radio frequency (RF) channels (e.g., RF1, RF2 being shown). The host dongle 231 is used to switch a controlled target of the input device 21 (i.e., a responder to input of the input device 21) associated with the first computer 251 between the first computer 251 and the multiple computers 232, 233.

In this way, the host computer 251 establishes RF channels RF1 and RF2 with multiple client computers (e.g., two computers 252 and 253 being shown, but not limited to two) via the host dongle 231 and the multiple client dongles 232 and 233, respectively. When the controlled target of the input devices 21 associated with the host computer 251 is being switched between the host computer 251 and multiple client computers 252 and 253, all RF channels RF1 and RF2 remain connection states simultaneously.

In one aspect, a switching order of the controlled target may be pre-recorded in the host dongle 231 and the multiple client dongles 232 and 233, or a user interface may be displayed when the first application software APP1 is executed, allowing users to set the switching order themselves. For example, the client dongle 232 is set as the first priority and the client dongle 233 is set as the second priority, or vice versa. That is, a first switching of the controlled target is from the first computer 251 to the second computer 252, and a second switching is from the second computer 252 to the third computer 253, or vice versa.

In another aspect, the controlled target of the input devices 21 is determined corresponding to boundaries of a screen of the host computer 251 where a cursor 301 (referring to FIG. 3) reaches.

In one aspect, the first application software APP1 is used to notify the host dongle 231 to switch the controlled target of the input device 21 to one of the multiple computers when the cursor 301 on a screen 251S of the first computer 251 reaches a predetermined boundary of the screen 251S.

Please refer to FIG. 3, for example when the cursor 301 reaches a left boundary of the screen 251S, the first application software APP1 notifies the host dongle 231 to switch the controlled target of the input device 21 to the second computer 252, and the operation events (such as information including clicks, wheel scrolling and displacement) received by the client dongle 232 via the RF channel RF1 are injected to the operating system (OS) of the second computer 252 for corresponding operations, e.g., moving a cursor 302 shown on a screen 252S of the second computer 252. Meanwhile, the first application software APP1 does not transmit the operation events of the input device 21 to the operating system (OS) of the first computer 251. That is, the first application software APP1 intercepts operation information of the input device 21 and transmits the intercepted operation information to the host dongle 231 to be forwarded to the client dongle 232, so that the input device 21 is used only to control the second computer 252 but not to control the first computer 251.

During the period that the input device 21 is controlling the second computer 252, the second application software APP2 is used to notify (e.g., send a signal from the client dongle 232 to the host dongle 231), via the associated RF channel RF1 when the cursor 302 on the screen 252S of the second computer 252 reaches a predetermined boundary (e.g., the left boundary) of the screen 252S of the second computer 252, the first application software APP1 to control the host dongle 231 to switch the controlled target of the input device 21 to another of the multiple client computers, such as the third computer 253. At this time, the input device 21 controls the third computer 253 through the RF channel RF2. Similarly, during the switching procedure of the controlled target from the second computer 252 to third computer 253, the RF channels RF1 and RF2 remain connection states simultaneously.

In addition, the second application software APP2 is further used to notify the first application software APP1 via the associated RF channel RF1 to control the host dongle 231 to switch the controlled target of the input device 21 back to the first computer 251 when the cursor 302 on the screen 252S of the second computer 252 reaches another predetermined boundary (e.g., the right boundary) of the screen 252S of the second computer 252, i.e. the first application software APP1 no longer intercepting the operation information of the input device 21 and the input device 21 being able to control the first computer 251.

Please refer to FIG. 3 again, for example when the cursor 301 reaches a right boundary of the screen 251S, the first application software APP1 notifies the host dongle 231 to switch the controlled target of the input device 21 to the portable device 254/255, and the received operation events (such as information including clicks, wheel scrolling and displacement) are injected to the operating system (OS) of the portable device 254/255 for corresponding operations, e.g., moving a cursor on a screen of the portable device 254/255. That is, the host dongle 231 is used to simulate a BT mouse and/or a BT keyboard for the portable device 254/255 via a Bluetooth connection with the host dongle 231. Meanwhile, the first application software APP1 does not transmit operation events from the input device 21 to the operating system (OS) of the first computer 251. That is, the first application software APP1 intercepts the operation information of the input device 21 and transmits the intercepted operation information to the portable device 254/255, so that the input device 21 is used only to control the portable device 254/255 but not to control the first computer 251.

In the present disclosure, during the host dongle 231 is switching the controlled target of the input device 21 to one of the multiple computers and the multiple portable devices, the connection states of all RF channels and all BT channels are maintained online simultaneously. More specifically, once the host dongle 231 establishes communication channels with the client dongles and the portable devices, all RF channels and all BT channels remain connected unless a distance among them exceeds a valid connection distance (e.g., identified using RSSI by dongle) or the user manually disconnects the connection. For example, the first application software APP1 may be used to display the connection states (e.g., by images or text) of the host dongle 231 with all RF channels and all BT channels at a predetermined position on a screen 251S of the first computer 251, so as to confirm current connected devices by users.

In addition, the RF channels RF1 and RF2 are also used to exchange Wi-Fi IP addresses between the first computer 251 and one of the multiple computers 252 and 253 to establish a Wi-Fi connection between the first computer 251 and one of the multiple computers for transmitting large amounts of data, such as file transferring or screen mirroring. The BT channels BT1 and BT2 are also used to exchange Wi-Fi IP addresses between the first computer 251 and one of the multiple portable devices 254 and 255 to establish a Wi-Fi connection between the first computer 251 and one of the portable devices for transmitting large amounts of data. The method of transferring encrypted files among computers and smartphones may be referred to U.S. patent application No. Ser. No. 18/425,528, entitled “WIRELESS COMMUNICATION SYSTEM HAVING MULTIPLE HOST COMPUTERS”, filed on Jan. 29, 2024 and assigned to the same assignee of the present application, the full disclosure of which is incorporated herein by reference, and thus details thereof are not described herein, but the present disclosure is not limited thereto.

It is appreciated that the physical spatial relationships (e.g., relative positions) of all devices shown in FIG. 3 may be determined by the user, and the present disclosure is not limited to that shown in FIG. 3. In one aspect, the user may also set the positional relationship of multiple dongles corresponding to the physical spatial relationship of every device through a human-machine interface of the first application software APP1.

Generally speaking, the operating system (OS) of a smartphone has higher limitations. When using a mouse (e.g., 21) to control a cursor on a screen of a smartphone (e.g., 254) via a dongle (e.g., 231), a computer (e.g., 251) cannot know a current position of the cursor (i.e., not able to know from the smartphone), and errors may occur when controlling the cursor, such as accidentally switching the cursor off the portable device 254. Accordingly, the present disclosure further provides a cursor control method of a communication system (taking 200 as an example).

As mentioned above, the communication system 200 includes a first computer 251 that establishes a first BT channel BT1 with a first portable device 254 via the host dongle 231. In this scenario, the RF channels RF1 and RF2 and the BT channel BT2 may exist or not.

Please refer to FIGS. 3 to 5 together, the cursor control method of the present disclosure includes the steps of:

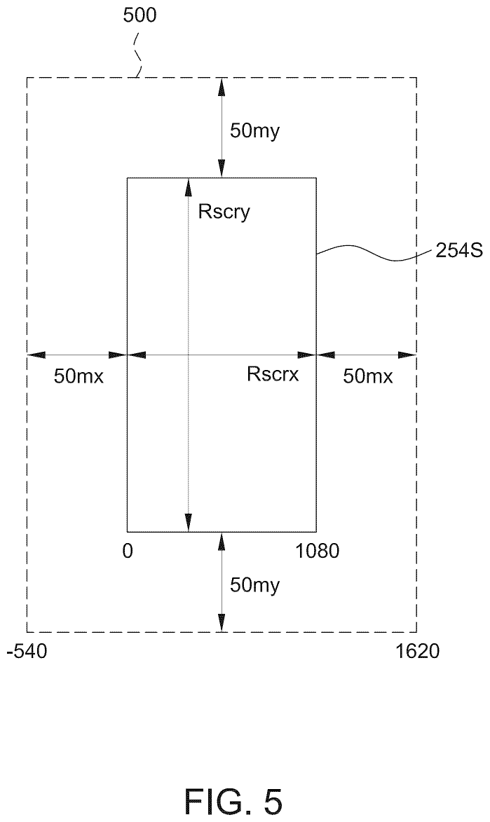

Steps S411-S414: The first computer 251 (more specifically the first application software APP1 thereof) obtains a screen resolution (i.e. a screen size, e.g., shown as Rscrx and Rscry in FIG. 5) of the first portable device 254 through the host dongle 231.

For example, after the first BT channel BT1 is established between the host dongle 231 and the first portable device 254, the first computer 251 sends a screen resolution request to the host dongle 231, Step S411. Next, the host dongle 231 forwards the screen resolution request to the first portable device 254 via the first BT channel BT1, Step S412. The first portable device 254 (e.g., application software APP4 thereof) then sends a screen resolution response back to the host dongle 231 via the first BT channel BT1, Step S413). Finally, the host dongle 231 forwards the screen resolution response back to the first computer 251, Step S414, such that the first computer 251 knows a screen size of a connected portable device, e.g., 254.

Step S42: The first computer 251 (more specifically, the first application software APP1) notifies the host dongle 231 to set the screen resolution and a buffer margin of the first portable device 254, more specifically, in a micro controller unit (MCU) thereof. Please refer to FIG. 5, the first portable device 254 includes a screen 254S, whose X-direction resolution is, for example, 0-1080 pixels, but not limited thereto. The first computer 251 also sets up a buffer margin 500 surrounding the screen 254S, e.g., shown as an X-direction buffer margin 50mx and a Y-direction buffer margin 50my. That is, the buffer margins 50mx and 50my are predetermined pixel areas exceeding the screen resolution. The X-direction buffer margin 50mx is, for example, 540 pixel-wide (e.g., less than or equal to a half of the X-direction resolution), but is not limited thereto. The effects of arranging the X-direction buffer margin 50mx and the Y-direction buffer margin 50my will be illustrated below by an example. Furthermore, the left and right X-direction buffer margins 50mx are not necessarily the same, and the upper and lower Y-direction buffer margins 50my are not necessarily the same.

It should be mentioned that although FIG. 5 shows that the buffer margins are configured in both sides in the X and Y directions, the present disclosure is not limited thereto. In an aspect that the cursor 304 can only enter/leave the screen 254S of the first portable device 254 from either the X or Y direction (e.g., predetermined or set via the user interface of APP1), buffer margins are configured only in either the X or Y direction. Furthermore, in an aspect that the cursor 304 can only enter/leave the screen 254S of the first portable device 254 from a single boundary in the X direction, a single-sided buffer margin is configured only in the X direction; and in an aspect that the cursor 304 can only enter/leave the screen 254S of the first portable device 254 from a single boundary in the Y direction, a single-sided buffer margin is configured only in the Y direction, which may be previously determined or set by a user manually via the first application software APP1.

Step S43: Preferably, before the cursor 304 is generated by controlling the cursor 301 to enter the first portable device 254, the host dongle 231 first resets a position of the cursor 304. For example, in an aspect that the cursor 304 can enter/leave the screen 254S of the first portable device 254 from both the X and Y directions, the cursor position may be reset to a center of the screen 254S; in an aspect that the cursor 304 can only enter/leave the screen 254S of the first portable device 254 from the left (or right) boundary in the X direction, the cursor position may be reset to the left (or right) boundary of the screen 254S; in an aspect that the cursor 304 can only enter/leave the screen 254S of the first portable device 254 from the upper (or lower) boundary in the Y direction, the cursor position may be reset to the upper (or lower) boundary of the screen 254S, but the present disclosure is not limited thereto. A reset position of the cursor is determined according to different applications.

Next, the first application software APP1 continuously monitors whether the cursor 301 reaches a predetermined boundary of the screen 251S of the first computer 251.

Step S44: When the cursor 301 on the screen 251S of the first computer 251 reaches a predetermined boundary (e.g., the right boundary) of the screen 251S, the first application software APP1 transmits the mouse events (e.g., including information of displacement, scroll wheel operation, and key operation) of the input device (e.g., still taking the mouse 21 as an example) to the host dongle 231.

Step S45: The MCU of the host dongle 231 processes the mouse events, including transmitting control displacement, scroll wheel operation information and key operation information to the first portable device 254 for corresponding control.

In one aspect, the control displacement is obtained by calculating an accumulated displacement MOV_accu. For example, the MCU of the host dongle 231 calculates an average speed within a predetermined time interval (e.g., 100 ms, but not limited to 100 ms). For example, a number of displacements used to calculate the average speed is determined based on a displacement reporting rate of the mouse 21 during the predetermined time interval. For example, the average speed Ave_x in the X direction is used as an example for illustration purposes herein.

When the average speed Ave_x is lower than a first speed TH_sp1, the accumulated displacement MOV_accu is added by a first displacement Disp1; when the average speed Ave_x is lower than a second speed TH_sp2 (which is higher than the first speed TH_sp1) and higher than the first speed TH_sp1, the accumulated displacement MOV_accu is added by a second displacement Disp2, which is greater than the first displacement Disp1; when the average speed Ave_x is higher than the second speed TH_sp2, the accumulated displacement MOV_accu is added by a third displacement Disp3, which is greater than the second displacement Disp2. That is, the accumulated displacement MOV_accu is not calculated by directly adding the displacement received from the mouse 21 but calculated by adding predetermined step values.

In one aspect, the accumulated displacement MOV_accu, the first displacement Disp1, the second displacement Disp2 and the third displacement Disp3 are in units of pixels.

In the present disclosure, the first displacement Disp1, the second displacement Disp2, the third displacement Disp3, the first speed TH_sp1, the second speed TH_sp2, the X-direction buffer margin 50mx and the Y-direction buffer margin 50my are determined corresponding to a screen resolution of different portable devices, e.g., determined by the first application software APP1.

The MCU of the host dongle 231 calculates the accumulated displacement MOV_accu every predetermined time interval, and transmits the mouse events to the first portable device 254 (step S451) to control a cursor 304 on the first portable device 254. In the present disclosure, the accumulated displacement MOV_accu is not used to control movement of the cursor 304 on the first portable device 254. The movement of the cursor 304 on the first portable device 254 is controlled by the displacement contained in the mouse events.

Step S49: When the mouse 21 is controlling the cursor 304 on the first portable device 254, the MCU of the host dongle 231 does not know a current position of the cursor 304 as mentioned above. Therefore, the MCU of the host dongle 231 continuously monitors whether the accumulated displacement MOV_accu exceeds the X direction buffer margin 50mx to determine whether the user wants to transfer the controlled target of the mouse 21 back to the first computer 251. For example, only when the MCU of the host dongle 231 determines that the accumulated displacement MOV_accu exceeds −540 (corresponding to the cursor 304 entering/leaving from a left boundary of screen 254S) or exceeds 1620 (corresponding to the cursor 304 entering/leaving from a right boundary of screen 254S), the MCU of the host dongle 231 notifies the first computer 251 to transfer the controlled target of the mouse 21 back to the first computer 251. In the present disclosure, when the MCU of the host dongle 231 determines that the accumulated displacement MOV_accu only exceeds the resolution of the screen 254S (e.g., boundary 0 or 1080) but does not exceed the X direction buffer margin 50mx, the controlled target of the mouse 21 is not switched back to the first computer 251.

To further prevent the cursor 304 from accidentally detaching from the first portable device 254, the present disclosure may additionally include the following steps:
Step S46: During the calculation of the accumulated displacement MOV_accu, the MCU of the host dongle 231 further determines whether the displacement from the mouse 21 has reversed in direction (considering that the user is not intended to control the cursor 304 to leave the first portable device 254), e.g., moving to the right (left) and then moving to the left (right), i.e. by comparing the displacement directions adjacent in the time axis. If no reversed displacement occurs, the process proceeds to the step S49.
Step S47: When a reversed displacement occurs, the MCU of the host dongle 231 determines whether the current accumulated displacement MOV_accu is located within the X direction buffer margin 50mx. If the current accumulated displacement MOV_accu is not within the X-direction buffer margin 50mx, the process then returns to the step S45 and the control displacement (e.g., the first displacement Disp1, the second displacement Disp2 or the third displacement Disp3) is transmitted to the first portable device 254 (Step S451). If the current accumulated displacement MOV_accu is within a part of the X-direction buffer margin 50mx, the host dongle 231 adjusts the accumulated displacement MOV_accu to a screen boundary adjacent to the part of the buffer margin where the accumulated displacement MOV_accu is located. For example, if the current accumulated displacement MOV_accu is in the range of 0 to −540, the host dongle 231 adjusts the accumulated displacement MOV_accu to or close to 0; if the current accumulated displacement MOV_accu is in the range of 1080 to 1620, the host dongle 231 adjusts the accumulated displacement MOV_accu to or close to 1080. In this way, the chance that the cursor 304 accidentally leaves the screen 254S of the first portable device 254 is effectively reduced.

It should be mentioned that the cursor control method of the present disclosure operates in the Y direction in a manner similar to the operation method in the X direction as described above, except for the direction, and thus details thereof are not described herein. In brief, if the current accumulated displacement MOV_accu is in the range of an upper buffer margin 50my, the host dongle 231 adjusts the accumulated displacement MOV_accu to or close to an upper boundary of the screen 254S; whereas if the current accumulated displacement MOV_accu is in the range of a lower buffer margin 50my, the host dongle 231 adjusts the accumulated displacement MOV_accu to or close to a lower boundary of the screen 254S.

It should be mentioned that although the present disclosure uses an example of moving the cursor to a screen boundary using a mouse to switch the controlled target of the input device, it is only intended to illustrate but not to limit the present disclosure. In other aspects, the first application software may APP1 may trigger the switching by monitoring a hotkey or other operation signals, for example, referring to U.S. patent application Ser. No. 18/425,528 owned by the same assignee of the present disclosure, but the present disclosure is not limited thereto, as long as the host dongle has recorded the switching order in advance (e.g., predetermined or set through the user interface of the first application software APP1).

It should be mentioned that in the present disclosure the host dongle 231 is pre-paired with each client dongle and each portable device. When a distance between the host dongle 231 and a client dongle or a portable device is less than a connectable range, the host dongle 231 automatically completes the connection based on the pairing information.

It should be mentioned that the buffer margin 500 mentioned in the present disclosure is not shown on the screen of the portable device, and users cannot see the buffer margin 500 visually.

It should be mentioned that although the input device 21 is shown to be wirelessly coupled to the dongle 231 or the computer 251 herein, the present disclosure is not limited thereto. In another aspect, the input device 21 is wired coupled to the computer 251, e.g., via a USB interface.

It should be mentioned that all values, such as a number of devices, a number of channels, the resolution, a number of pixels, and the spatial relationship between devices mentioned in the present disclosure are only intended to illustrate but not to limit the present disclosure.

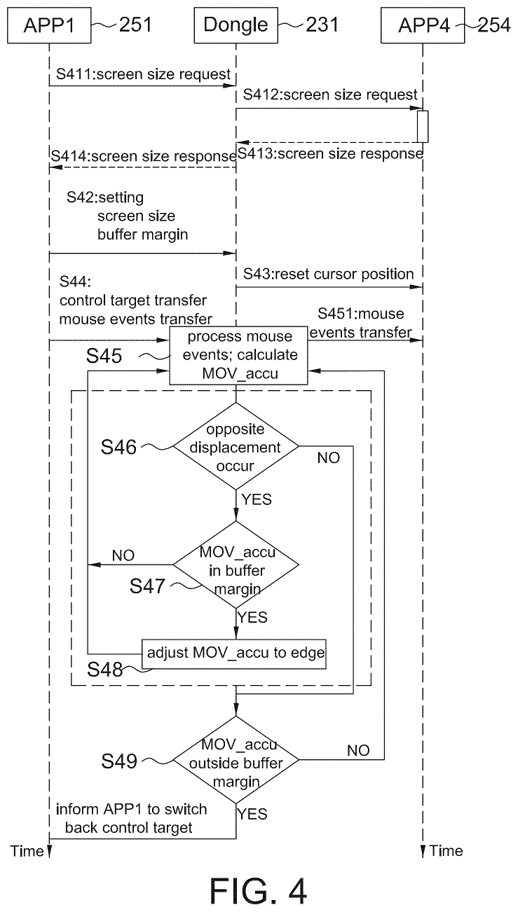

As mentioned above, although a conventional wireless mouse can switch a controlled target among multiple computers, the wireless mouse can only connect to one computer at a time. Therefore, during the switching procedure, a current connection must be disconnected and then a new connection is established, resulting in a switching time delay. Accordingly, the present disclosure further provides a communication system (e.g., FIGS. 2-3) in which the controlled target is switched while all RF channels and all BT channels are kept online simultaneously, so as to eliminate the problem of switching time delay. In addition, the communication system of the present disclosure may also configure an additional buffer margin outside a screen size (e.g., referring to FIG. 4) when the cursor is manipulated on a screen of the portable device, which can reduce the chance that the user accidentally cuts the cursor off the screen of the portable device, thereby improving the user experience.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. A communication system, comprising:
a host dongle, comprising a universal serial bus (USB) interface configured to be coupled to a first computer;
multiple client dongles, respectively comprising a USB interface configured to be coupled to multiple computers, respectively,
wherein the host dongle is configured to keep connection states with the multiple client dongles simultaneously via respective radio frequency (RF) channels to switch a controlled target of an input device associated with the first computer between the first computer and the multiple computers.

2. The communication system as claimed in claim 1, wherein the input device comprises:
input equipment embedded in the first computer, and
input equipment wired or wirelessly coupled to the first computer.

3. The communication system as claimed in claim 1, wherein the first computer is installed with a first application software, which is configured to notify the host dongle to switch the controlled target of the input device to one of the multiple computers when a cursor on a screen of the first computer reaches a predetermined boundary of the screen.

4. The communication system as claimed in claim 3, wherein all the RF channels keep the connection states during the host dongle switching the controlled target of the input device to one of the multiple computers.

5. The communication system as claimed in claim 1, wherein the RF channels are further configured to exchange Wi-Fi IP addresses between the first computer and one of the multiple computers to establish a Wi-Fi channel between the first computer and the one of the multiple computers.

6. The communication system as claimed in claim 1, wherein
the host dongle is further configured to establish a first Bluetooth (BT) channel with a first portable device via a first BT interface, and
the host dongle is further configured to keep connection states of multiple RF channels and the first BT channel.

7. The communication system as claimed in claim 6, wherein
the host dongle is further configured to establish a second BT channel with a second portable device via a second BT interface, and
the host dongle is further configured to keep connection states of the multiple RF channels, the first BT channel and the second BT channel.

8. The communication system as claimed in claim 6, wherein the first computer is installed with a first application software, which is configured to notify the host dongle to switch the controlled target of the input device to the first portable device to simulate a BT mouse or a BT keyboard when a cursor on a screen of the first computer reaches a predetermined boundary of the screen.

9. A communication system, comprising:
a host computer, installed with a first application software and coupled to a first dongle;
multiple client computers, respectively installed with an application software and respectively coupled to a dongle,
wherein the host computer is configured to respectively establish an RF channel with multiple dongles coupled to the multiple client computers via the first dongle, and
in switching a controlled target of an input device associated with the host computer between the host computer and the multiple client computers, all RF channels are kept connection states simultaneously.

10. The communication system as claimed in claim 9, wherein the input device comprises:
input equipment embedded in the host computer, and
input equipment wired or wirelessly coupled to the host computer.

11. The communication system as claimed in claim 9, wherein the first application software is configured to notify the first dongle to switch the controlled target of the input device to a second computer among the multiple computers when a cursor on a first screen of the host computer reaches a first predetermined boundary of the first screen.

12. The communication system as claimed in claim 11, wherein a second application software of the second computer is configured to notify, via an associated RF channel, the first application software to control the first dongle to switch the controlled target of the input device to another computer among the multiple computers when a cursor on a second screen of the second computer reaches a second predetermined boundary of the second screen.

13. The communication system as claimed in claim 9, wherein the RF channels are further configured to exchange Wi-Fi IP addresses between the host computer and one of the multiple client computers to establish a Wi-Fi channel between the host computer and the one of the multiple client computers.

14. The communication system as claimed in claim 9, further comprising:
a first portable device, configured to establish a first BT channel with the first dongle to form a first BT connection with the first dongle,
wherein the first BT channel and the all RF channels are kept connection states simultaneously.

15. The communication system as claimed in claim 14, further comprising:
a second portable device, configured to establish a second BT channel with the first dongle to form a second BT connection with the first dongle,
wherein the first BT channel, the second BT channel and the all RF channels are kept connection states simultaneously.

16. The communication system as claimed in claim 14, wherein the first application software is configured to notify the first dongle to switch the controlled target of the input device to the first portable device to simulate a BT mouse or a BT keyboard when a cursor on a screen of the host computer reaches a predetermined boundary of the screen.

17. A cursor control method of a communication system, the communication system comprising a computer establishing a BT channel with a portable device via a dongle, the cursor control method comprising:
acquiring, by the computer, a screen resolution of the portable device via the dongle;
notifying, by the computer, the dongle to set the screen resolution and a buffer margin of the portable device, wherein the buffer margin is a predetermined pixel region exceeding the screen resolution;
forwarding displacement of a mouse to the dongle upon a cursor on a screen of the computer reaching a predetermined boundary of the screen;
calculating, by the dongle, an accumulated displacement and controlling a cursor on the portable device according to the displacement forwarded from the mouse; and
notifying, by the dongle, the computer to switch a controlled target of the mouse back to the computer only when the accumulated displacement exceeds the buffer margin.

18. The cursor control method as claimed in claim 17, further comprising:
identifying, by the dongle, whether the displacement from the mouse has an opposite displacement;
identifying, by the dongle, whether the accumulated displacement is within the buffer margin upon the opposite displacement is identified; and
adjusting, by the dongle, the accumulated displacement to a screen boundary adjacent to a part of the buffer margin in which the accumulated displacement is located when the accumulated displacement is within the part of the buffer margin.

19. The cursor control method as claimed in claim 18, further comprising:
calculating, by the dongle, an average speed within a predetermined time interval;
adding a first displacement to the accumulated displacement when the average speed is lower than a first speed;
adding a second displacement, which is larger than the first displacement, to the accumulated displacement when the average speed is lower than a second speed, which is larger than the first speed, and higher than the first speed; and
adding a third displacement, which is larger than the second displacement, to the accumulated displacement when the average speed is higher than the second speed.

20. The cursor control method as claimed in claim 19, further comprising:
not switching the controlled target of the mouse back to the computer when the accumulated displacement exceeds the screen resolution but still within the buffer margin.
